(19) United States
(12) Patent Application Publication
(10) Pub. No.: US 2015/0145300 A1
(43) Pub. Date: May 28, 2015

(54) METHOD AND APPARATUS FOR ADJUSTING THE SPACING OF VEHICLE SEATS BASED ON THE SIZE OF THE SEAT OCCUPANT

(71) Applicant: B/E Aerospace, Inc., Wellington, FL (US)

(72) Inventors: Travis K. Finlay, Winston-Salem, NC (US); Glenn Allen Johnson, Rural Hall, SC (US); Pierre J. Vignal, Winston-Salem, NC (US)

(21) Appl. No.: 14/547,932

(22) Filed: Nov. 19, 2014

Related U.S. Application Data
(60) Provisional application No. 61/909,455, filed on Nov. 27, 2013.

(51) Int. Cl. B64D 11/06; B64C 1/20

(52) U.S. Cl. CPC B64D 11/064; B64D 11/0696; B64C 1/20
USPC 297/257

(57) ABSTRACT

A passenger seat assembly for permitting adjustment of the spacing of a passenger seat row relative to a fore or aft passenger seat row that includes first and second seat tracks for being positioned on the deck of an aircraft and extended along a longitudinal axis of an aircraft passenger area of the aircraft. Seat legs support a seat bottom and seat back of a plurality of seats in the seat row. First and second slides are provided for being affixed to respective ones of the first and second tracks. The first and second pairs of seat legs are adapted for being mounted on the slides and positioned for sliding movement on the tracks. First and second drive assemblies are provided for being positioned intermediate the seats and tracks and adapted to move the seats carried by the seat legs fore and aft in the tracks. A related method is also disclosed.

### CROSS REFERENCE TO RELATED PATENT APPLICATIONS

This application is based on and claims priority to U.S. Provisional Patent Application No. 61/909,455, filed Nov. 27, 2013, the contents of which are incorporated into this application in its entirety.

### TECHNICAL FIELD AND BACKGROUND OF THE INVENTION

The present invention relates to a method and apparatus for adjusting the spacing of seats based on the size of the passengers occupying the seats, particularly aircraft passengers. While passengers come in many sizes - children, adolescents, adults, men, women and with large height differentials within these categories, seat spacing in the main cabin of passenger aircraft is generally uniform except at exit rows. This “one size fits all” seating arrangement can cause discomfort for tall passengers, while a child or relatively small adult may be seated in an identical seat at the same pitch with more than ample leg room and in relative comfort.

Passengers are “sized” according to standards within the aircraft industry, so data exists by which passenger height can be determined both in absolute and relative terms. The largest size male and female standard height is considered a 100 percent male or female, so that a 90 percent male would have a height that, according to the size criteria, would be 90 percent of the height of the 100 percent male.

### SUMMARY OF THE INVENTION

Therefore, it is an object of the invention to provide a method of seating passengers according to height, and then adjusting the spacing of the seat to accommodate the height of the passenger in each seat.

It is another object of the invention to provide a seating apparatus that enables passengers to be seated according to height, and then adjusting the spacing fore and aft of the seat to accommodate the height of the passenger in each seat.

In accordance with one embodiment of the invention, a passenger's height is determined at check-in. Once most passengers are checked-in, the seating on the aircraft may be adjusted to better accommodate tall and short passengers, for example, by placing several 95% males behind a row of small children no taller than a 30% female. Even a relatively small incremental increase in seat spacing for the tall passengers can provide additional comfort with no loss of comfort to the much smaller passengers seated in front of the tall passengers.

In accordance with another embodiment of the invention, this adjustment is done with a handheld device, for example a “tablet”, via wireless communication with a controller mounted on each seat that moves the seat fore or aft as commanded. An attendant walking through the aircraft with the tablet can initiate the adjustment as well as verify or make corrections to the adjustments.

In accordance with another embodiment of the invention, the adjustment mechanism includes a motor driving a gear that interfaces with the existing seat track.

In accordance with another embodiment of the invention, a passenger seat assembly is provided for permitting adjustment of the spacing of a passenger seat row relative to a fore or aft passenger seat row, and includes first and second seat tracks for being positioned on the deck of an aircraft and extended along a longitudinal axis of an aircraft passenger area of the aircraft. Seat legs support a seat bottom and seat back of a plurality of seats in the seat row. First and second slides are provided for being affixed to respective ones of the first and second tracks. The first and second pairs of seat legs are adapted for being mounted on the slides and positioned for sliding movement on the tracks. First and second drive assemblies are provided for being positioned intermediate the seats and tracks and adapted to move the seats carried by the seat legs fore and aft in the tracks.

According to another embodiment of the invention, the first and second drive assemblies each comprise a cog gear mounted for rotation on a gear support attached to and extending between the seat legs, the cog having a plurality of drive cogs around its periphery that fit into enlarged openings in the track, and a drive motor for rotating the cog gear to move the seats fore or aft to change the pitch of the seat row.

According to another embodiment of the invention, the drive motor includes a worm gear for being rotated by the motor and the cog gear includes teeth adapted for being meshed with the worm gear for rotating the cog gear.

According to another embodiment of the invention, the drive motor is positioned to rotate a vertically-oriented drive shaft and worm gear, the cog gear is mounted for rotation on a horizontal axis and includes teeth adapted for being meshed with the worm gear for rotating the cog gear, and the drive cogs are positioned on the cog gear for concentric movement with the teeth.

According to another embodiment of the invention, a plurality of seat rows are provided for being positioned in spaced-apart relation along a predetermined length of an aircraft passenger cabin.

According to another embodiment of the invention, a wireless receiver and transmitter are adapted to receive a signal indicating a seat row position and to transmit a signal commanding movement of a seat row to a different position; and a motor controller is provided for receiving the signal commanding movement and transmitting the signal commanding movement to the drive motor.

According to another embodiment of the invention, at least one hand held device having a graphical user interface is provided for permitting operation of the passenger seat assembly.

According to another embodiment of the invention, an apparatus is provided for permitting adjustment of the spacing of a passenger seat row relative to a fore or aft passenger seat row, and includes first and second seat tracks positioned on the deck of an aircraft, extending along a longitudinal axis of an aircraft passenger area of the aircraft and having respective spaced-part enlarged openings along their respective lengths. First and second pairs of seat legs support a seat bottom and seat back of a plurality of seats in the seat row. First and second slides are affixed to respective ones of the first and second tracks. The first and second pairs of seat legs are positioned for movement with the respective first and second slides. First and second cog gears are positioned between the respective first and second pairs of seat legs, and have cogs on a driving surface for engaging the enlarged openings of the tracks and rotate to move the seats carried by the seat legs fore and aft in the tracks.

According to another embodiment of the invention, a plurality of seat rows is provided for being positioned in spaced-apart relation along a predetermined length of an aircraft passenger cabin.

According to another embodiment of the invention, a wireless receiver and transmitter is provided and is adapted to receive a signal indicating a seat row position and to transmit a signal commanding movement of a seat row to a different position. A motor controller is provided for receiving the signal commanding movement and transmitting the signal commanding movement to the drive motor.

According to another embodiment of the invention, at least one hand held device is provided having a graphical user interface for permitting operation of the passenger seat assembly.

According to another embodiment of the invention, a method of adjusting the pitch between a plurality of seat rows in passenger aircraft cabin is provided and includes the steps of mounting the seat rows for movement along at least one seat track mounted on a deck of the aircraft cabin, providing at least one motor for moving the seats along the at least one seat track, determining that the pitch between two seat rows should be increased or decreased, and activating the at least one motor causing the pitch to increase or decrease as desired.

According to another embodiment of the invention, the method includes the step of electronically communicating between a user and the motor wirelessly.

According to another embodiment of the invention, a method of adjusting the pitch between a plurality of seat rows in passenger aircraft cabin is provided and includes the steps of providing first and second seat tracks for being positioned on the deck of an aircraft and extended along a longitudinal axis of an aircraft passenger area of the aircraft and seat legs supporting a seat bottom and seat back of a plurality of seats in the seat row. First and second slides are provided for being affixed to respective ones of the first and second tracks, the first and second pairs of seat legs are adapted for being mounted on the slides and positioned for sliding movement on the tracks. First and second drive assemblies are provided for being positioned intermediate the seats and tracks and adapted to move the seats carried by the seat legs fore and aft in the tracks. A determination is made regarding whether the pitch between two seat rows should be increased or decreased. The first and second drive assemblies are activated, causing the pitch to increase or decrease as desired.

According to another embodiment of the invention, method includes the steps of wirelessly receiving a signal indicating a seat row position wirelessly transmitting a signal to a motor controlling the pitch of the seat row, commanding movement of a seat row to a different position.

According to another embodiment of the invention, the method includes the step of using at least one hand held device having a graphical user interface for permitting operation of the passenger seat assembly.

### BRIEF DESCRIPTION OF THE DRAWING FIGURES

The present invention is best understood when the following detailed description of the invention is read with reference to the accompanying drawings, in which:

FIG. 1 is a perspective view of a segment of an aircraft passenger seating area, and a representation of a handheld device with a representation of the seating area displayed to a flight attendant to enable adjustment of the seat spacing;

FIG. 2 is an enlarged perspective view of the segment of an aircraft passenger seating area displayed on the handheld device to enable adjustment of the seat spacing;

FIGS. 3 and 4 are side elevation and perspective views, respectively, of the adjustment mechanism of the seat; and

FIGS. 5 and 6 are side elevations of several rows of seats illustrating by comparison the improvement in comfort providing by being able to adjust the pitch of the seats to accommodate the height of the passengers.

### DETAILED DESCRIPTION OF THE PREFERRED EMBODIMENT

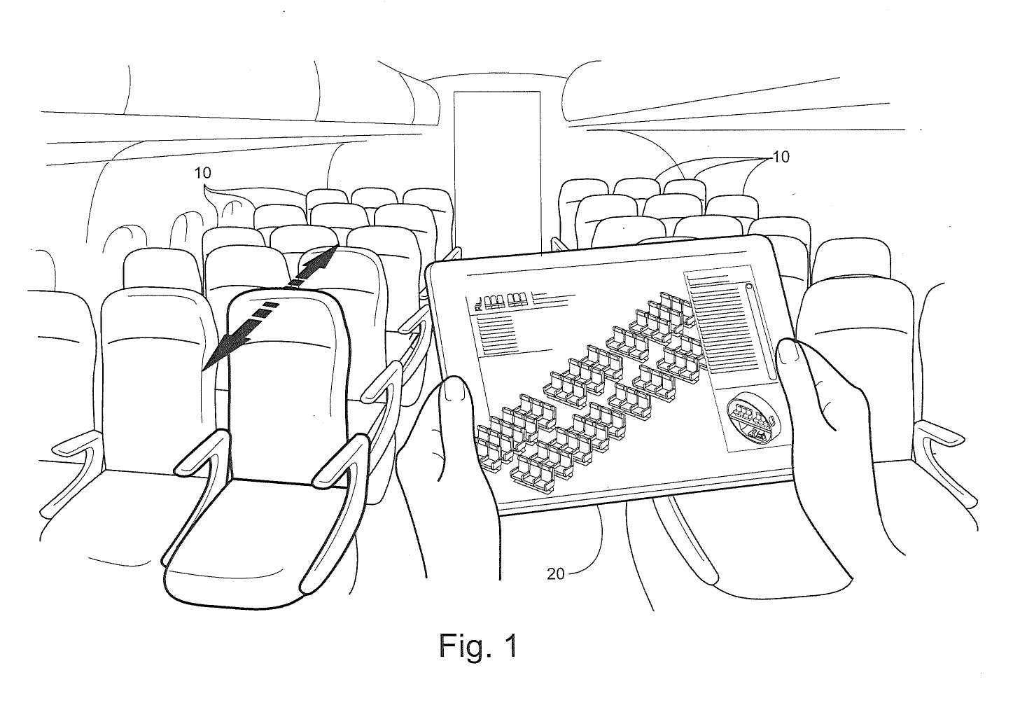

Referring now specifically to the drawings, FIG. 1 illustrates a passenger seating area containing rows of passenger seats 10. As shown in the foreground of FIG. 1, a flight attendant is holding a handheld device 20 such as a tablet on which is displayed a graphic representation of the seating area layout. The touch screen feature of the handheld device 20 allows the flight attendant to adjust the seat spacing to accommodate passengers of differing heights.

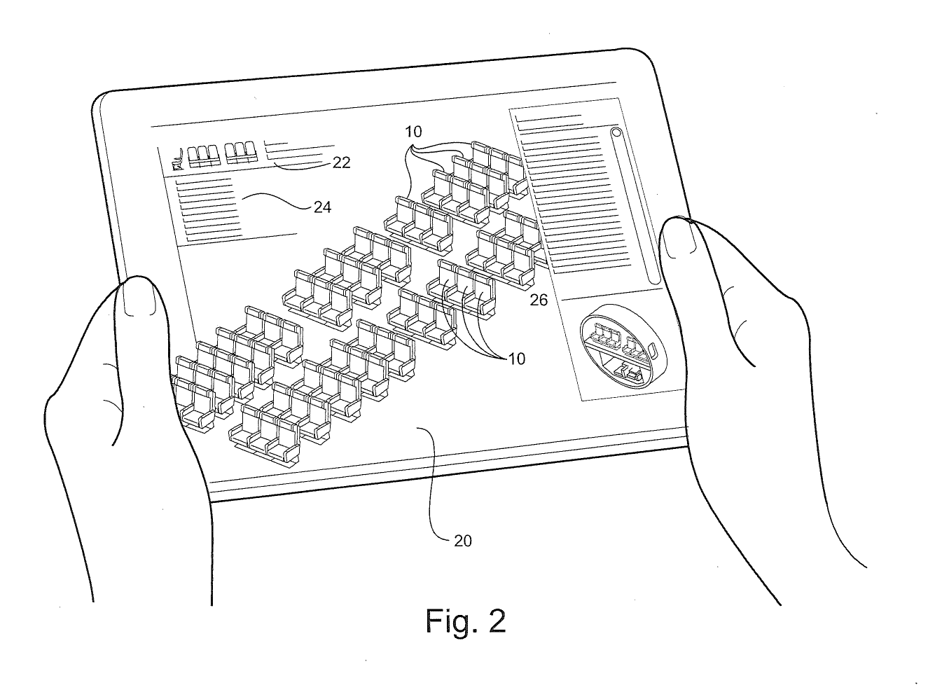

FIG. 2 illustrates that the display includes information that includes a front elevation of a selected row 22, together with instructions to change the pitch of the row. By observing the size of the passengers seated in each row, adjustments can be made row by row to achieve maximum comfort. Individual rows are indicated by letter on a list 24.

According to a preferred embodiment of the invention, passenger size can be determined before or during boarding of the aircraft. Passengers can be seated according to height in a manner that would place tall passengers in front of or behind shorter passengers, for example, or passengers seated randomly can be observed and adjustments made where possible. With tall passengers seated in front of shorter passengers, the tall passenger seats can be moved rearward to increase the pitch of the tall passengers' seats and correspondingly decrease the pitch of the short passengers' seats. Conversely, if the tall passengers are seated to the rear of the shorter passengers, the short passenger seats can be moved forward to increase the pitch of the tall passengers' seats and correspondingly decrease the pitch of the short passengers' seats. As shown in FIG. 2, a passenger and cargo manifest 26 is also available to the flight attendant.

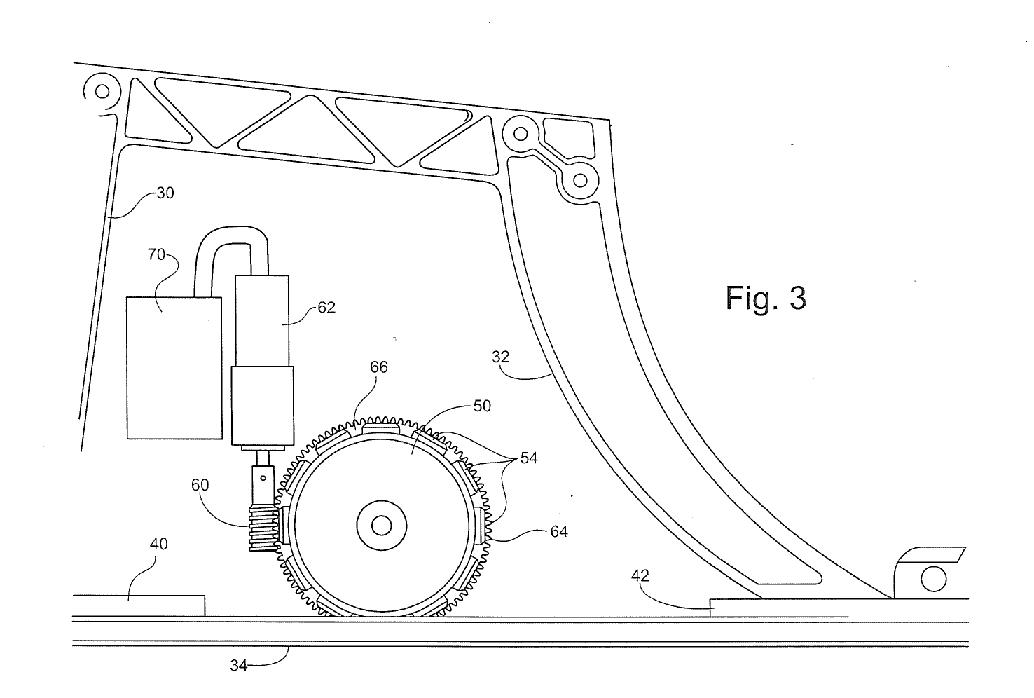

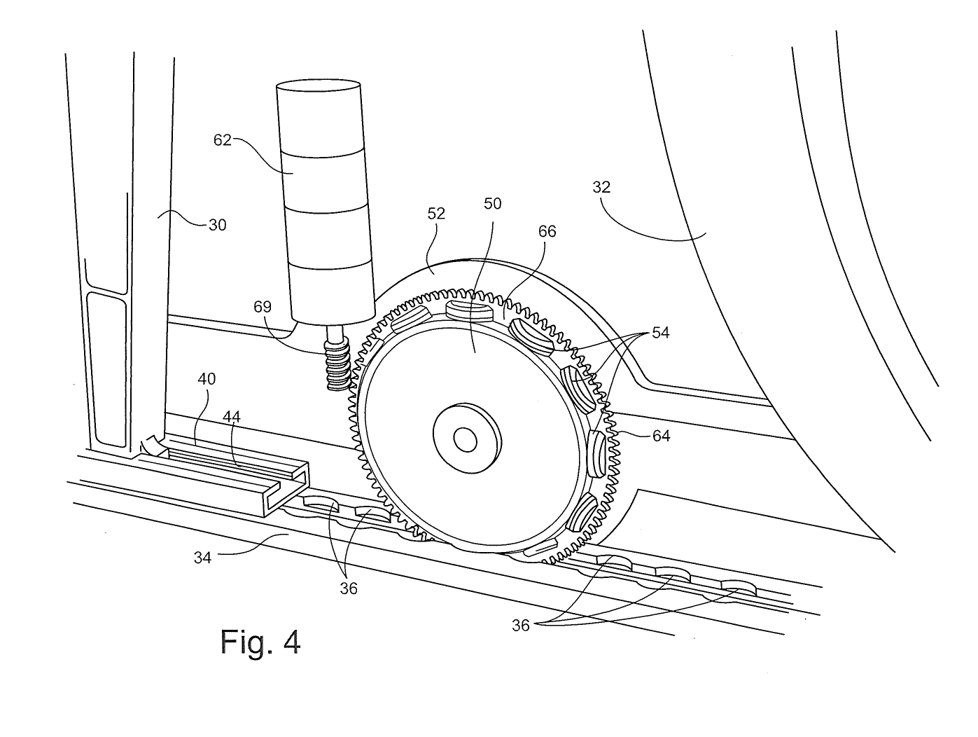

Referring now to FIGS. 3 and 4, each seat row includes three seats that are mounted on legs. Legs 30 and 32 are representative of the seating structure of each seat row. A track 34 includes a series of equally spaced-apart enlarged openings 36 into which are fitted fore and aft slides 40, 42. The slides 40, 42 are fixed into the track in a specified location and are maintained in a stationary position. Both slides 40, 42 are hollow with a top-opening slot, for example slot 44 in slide 40. The seat legs 30, 32 are held by enlarged feet in the slots.

A cog gear 50 is mounted for rotation on a gear support 52, FIG. 4, attached to and extending between the fore and aft legs 30, 32. The cog gear 50 has a plurality of drive cogs 54 around its periphery that fit into the enlarged openings 36 in the track 34. The cog gear 50 is rotated by a worm 60 driven by a drive motor 62. The worm 60 has a threaded section that engages the teeth 64 of a worm gear 66 mounted concentrically on the cog gear 50, as shown. The drive cogs 54 lock into the enlarged openings 36 of the track 34 and lock the row of seats 10 into a specific pitch. Note that each seat row has two of the mechanisms described above, one on the inboard and one on the outboard side, that operate in unison to move the seats 10 fore and aft. A wireless receiver 70 receives a signal from the handheld device 20 that commands the seat movement described above.

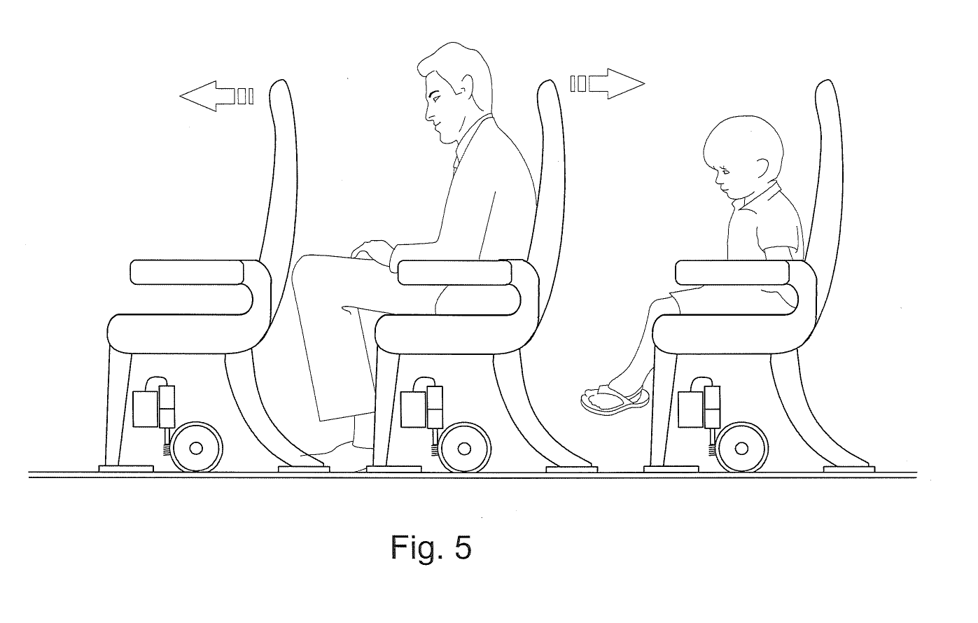

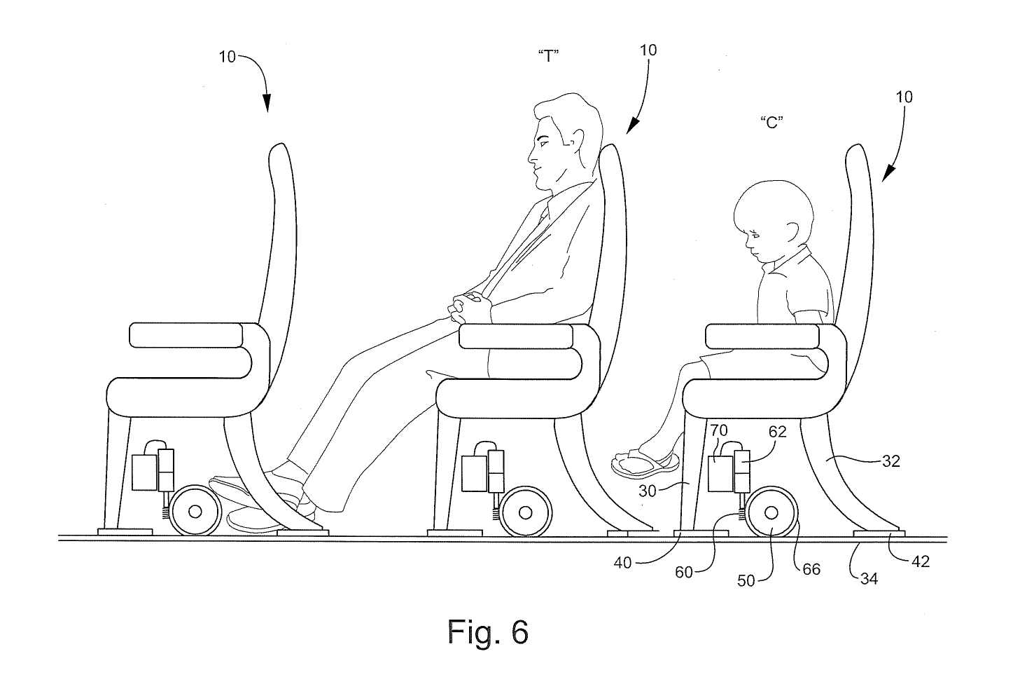

An example of the apparatus and method is illustrated by comparing the views shown in FIGS. 5 and 6. In the FIG. 5, the tall passenger “T” has virtually no knee room, while the aft-seated child “C” has more than sufficient leg room. As shown in FIG. 6, shifting the child's “C” seat 10 rearward slightly provides greater leg room for the tall passenger “T” without in any way impairing the comfort of the child “C.” FIG. 6 also indicates that the seat 10 forward of the tall passenger “T” is moved forward, which can provide additional pitch if the height of the passenger seated in the seat 10 forward of the tall passenger permits the shift forward. Of course, in practice a decision in a specific instance to move the forward seat, rearward seat or both is determined by the height of the seat occupants.

A method and apparatus for adjusting the spacing of seats based on the size of passengers according to the invention have been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. A passenger seat assembly for permitting adjustment of the spacing of a passenger seat row relative to a fore or aft passenger seat row, comprising:
(a) first and second seat tracks for being positioned on the deck of an aircraft and extended along a longitudinal axis of an aircraft passenger area of the aircraft;
(b) seat legs supporting a seat bottom and seat back of a plurality of seats in the seat row:
(c) first and second slides for being affixed to respective ones of the first and second tracks;
(d) the first and second pairs of seat legs adapted for being mounted on the slides and positioned for sliding movement on the tracks; and
(e) first and second drive assemblies for being positioned intermediate the seats and tracks and adapted to move the seats carried by the seat legs fore and aft in the tracks.

2. A passenger seat assembly according to claim 1, wherein the first and second drive assemblies each comprise a cog gear mounted for rotation on a gear support attached to and extending between the seat legs, the cog having a plurality of drive cogs around its periphery that fit into enlarged openings in the track, and a drive motor for rotating the cog gear to move the seats fore or aft to change the pitch of the seat row.

3. A passenger seat assembly according to claim 2, wherein the drive motor includes a worm gear for being rotated by the motor, and the cog gear includes teeth adapted for being meshed with the worm gear for rotating the cog gear.

4. A passenger seat assembly according to claim 2, wherein the drive motor is positioned to rotate a vertically-oriented drive shaft and worm gear, the cog gear is mounted for rotation on a horizontal axis and includes teeth adapted for being meshed with the worm gear for rotating the cog gear, and the drive cogs are positioned on the cog gear for concentric movement with the teeth.

5. A passenger seat assembly according to claim 1, and including a plurality of seat rows for being positioned in spaced-apart relation along a predetermined length of an aircraft passenger cabin.

6. A passenger seat assembly according to claim 5, including a wireless receiver and transmitter adapted to receive a signal indicating a seat row position and to transmit a signal commanding movement of a seat row to a different position; and further including a motor controller for receiving the signal commanding movement and transmitting the signal commanding movement to the drive motor.

7. A passenger seat assembly according to claim 6, and including at least one hand held device having a graphical user interface for permitting operation of the passenger seat assembly.

8. An apparatus for permitting adjustment of the spacing of a passenger seat row relative to a fore or aft passenger seat row, comprising:
(a) first and second seat tracks positioned on the deck of an aircraft, extending along a longitudinal axis of an aircraft passenger area of the aircraft and having respective spaced-part enlarged openings along their respective lengths;
(b) first and second pairs of seat legs supporting a seat bottom and seat back of a plurality of seats in the seat row:
(c) first and second slides affixed to respective ones of the first and second tracks;
(d) the first and second pairs of seat legs positioned for movement with the respective first and second slides; and
(e) first and second cog gears positioned between the respective first and second pairs of seat legs, and having cogs on a driving surface for engaging the enlarged openings of the tracks and rotatable to move the seats carried by the seat legs fore and aft in the tracks.

9. A passenger seat assembly according to claim 8, and including a plurality of seat rows for being positioned in spaced-apart relation along a predetermined length of an aircraft passenger cabin.

10. A passenger seat assembly according to claim 8, including a wireless receiver and transmitter adapted to receive a signal indicating a seat row position and to transmit a signal commanding movement of a seat row to a different position; and further including a motor controller for receiving the signal commanding movement and transmitting the signal commanding movement to the drive motor.

11. A passenger seat assembly according to claim 10, and including at least one hand held device having a graphical user interface for permitting operation of the passenger seat assembly.

12. A method of adjusting the pitch between a plurality of seat rows in passenger aircraft cabin, comprising the steps of:
(a) mounting the seat rows for movement along at least one seat track mounted on a deck of the aircraft cabin;
(b) providing at least one motor for moving the seats along the at least one seat track;
(c) determining that the pitch between two seat rows should be increased or decreased; and
(d) activating the at least one motor causing the pitch to increase or decrease as desired.

13. A method according to claim 12, and including the step of electronically communicating between a user and the motor wirelessly.

14. A method of adjusting the pitch between a plurality of seat rows in passenger aircraft cabin, comprising the steps of:
(a) providing:
(I) first and second seat tracks for being positioned on the deck of an aircraft and extended along a longitudinal axis of an aircraft passenger area of the aircraft;
(ii) seat legs supporting a seat bottom and seat back of a plurality of seats in the seat row:
(iii) first and second slides for being affixed to respective ones of the first and second tracks;
(iv) the first and second pairs of seat legs adapted for being mounted on the slides and positioned for sliding movement on the tracks; and
(v) first and second drive assemblies for being positioned intermediate the seats and tracks and adapted to move the seats carried by the seat legs fore and aft in the tracks;
(b) determining that the pitch between two seat rows should be increased or decreased; and
(d) activating the first and second drive assemblies causing the pitch to increase or decrease as desired.

15. A method according to claim 14, including the steps of wirelessly receiving a signal indicating a seat row position wirelessly transmitting a signal to a motor controlling the pitch of the seat row, commanding movement of a seat row to a different position.

16. A passenger seat assembly according to claim 15, and including the step of using at least one hand held device having a graphical user interface for permitting operation of the passenger seat assembly.
